(19) United States
(12) Patent Application Publication
(10) Pub. No.: US 2022/0392315 A1
(43) Pub. Date: Dec. 8, 2022

(54) CARD GAME

(71) Applicant: Mark Harlow, Middleton (AU)

(72) Inventor: Mark Harlow, Middleton (AU)

(21) Appl. No.: 17/889,953

(22) Filed: Aug. 17, 2022

Related U.S. Application Data
(63) Continuation-in-part of application No. 16/480,151, filed on Jul. 23, 2019, now abandoned.

(30) Foreign Application Priority Data
Jan. 31, 2017 (AU) 2017900271

(51) Int. Cl. G07F 17/32; G06F 7/58

(52) U.S. Cl. CPC G07F 17/3293; G07F 17/3244; G07F 17/3262; G06F 7/588

(57) ABSTRACT

A card game for playing in a casino environment, with a dealer and one or more players. Before play commences the players place an ante bet. Each player and the dealer are then dealt 2 cards. The object of the game is to get a pair of cards scoring higher than the dealer, with a wild card being able to make a pair with any other card and two wild cards being the highest score possible. Without a pair the score is determined by the sum of the card's numeric values. Before the dealer reveals their cards, the players inspect their cards and can either forfeit their ante bet, or place a further bet equivalent to the original ante bet. A side bet is also available for receiving one or two wild cards.

### FIELD OF THE INVENTION

The present invention relates to a card game suitable for casino gambling tables or online equivalents.

### BACKGROUND TO THE INVENTION

The present invention is a card game and is discussed in terms of a casino environment and being played on a gaming table. It is to be understood that the card game of the invention may also be implemented by a computing system and played online or on dedicated machines.

Card games have historically been popular in casinos, however they have been on the decline in recent years as they have become stale. Patrons have also turned away from traditional card games as many casinos have changes the rules, often leading to confusion or a sense of unfairness.

Casinos are actively seeking new card games to entice patrons to their casinos. There is even an annual competition held in Las Vegas for new games. To be adopted by casinos a game must be quick to learn, quick to play, have some excitement for the patrons and offer the casinos a reasonable and statistically predictable return. For over twenty years no new game has had enough appeal to be widely adopted by the casinos.

The object of this invention is to provide a new card game to alleviate the above problem, or at least provide the public with a useful alternative.

### SUMMARY OF THE INVENTION

In a first aspect the invention provides a method of playing a card game between a dealer and a player using a plurality of cards including at least two wild cards, comprising: the player placing an ante bet; the dealer dealing 2 cards to the player and 2 cards to themselves; the player inspecting the cards that the player has been dealt and on consideration of the cards either forfeiting the ante or placing a bet equivalent to the ante bet; the dealer revealing the cards that dealer has been dealt; determining the winner of the game by comparing the cards dealt to the dealer with the cards dealt to the player in accordance with a set of card scoring rules; and, if the player is determined to be the winner then paying the player a payout in accordance to a set of payout rules.

Preferably the method includes the further step of the player placing a bet on receiving at least one wild card.

Preferably the game is played with at least one deck of custom cards, each deck comprising 2 wild cards and four each of numeric cards with values from 1 to 12.

The game may also be played with at least one deck of standard playing cards, each deck comprising 2 jokers, and 4 each of aces, kings, queens, jacks and numeric cards from 2 to 10, and wherein the jokers assume the role of wild cards.

Preferably the aces assume a numeric value of 11 and the kings, queens, and jacks assume a numeric value of 10.

Some embodiments of the invention are directed to systems and methods configured to enable secure wagering gaming operations through a computerized platform, the computerized platform comprising one or more of each of a data storage device, a processor, a display device, a memory storing a plurality of card images representing standard playing cards, each card image being associated with a card rank and numerical value, a random number generator and a data communication device, the processor being configured to execute code stored in the data storage device to enable the computerized platform to: detect receipt through the data communication device of an ante wager received as credit from a player account; responsive to detecting receipt of the wager, actuate the random number generator to randomly generate card images from the plurality of card images stored in memory to form a player hand of a first card and a second card and a dealer hand of a first card and a second card, the plurality of cards images stored in memory including at least one unique card image designated as a wild card, wherein responsive to the wild card being randomly generated to the player hand or the dealer hand, the wild card being assigned by the processing device as having the same card rank as the card rank of the second card; receive a player selection, the player selection being one of forfeiting the ante wager or continuing to a final outcome, the player selection to continue to a final outcome corresponding with the receipt through the data communication device of an additional amount of credit, wherein the additional amount of credit is equal to the ante wager; responsive to receiving the additional amount of credit, display the first card and the second card in the dealer hand on the display device; responsive to the first card and the second card of the dealer hand having a different card rank, the processor combining the numerical value of the first card and the second card of the dealer hand to determine a combined numerical value for the dealer hand, wherein a final outcome is determined as a player win responsive to the combined numerical value for the dealer hand being greater than a preset numerical value and one of: (i) the first card and the second card of the player hand having the same card rank; or (ii) the first card and the second card of the player hand having a different card rank and a combined numerical value determined by the processor to be greater than the combined numerical value for the dealer hand; responsive to the first card and the second card of the dealer hand having the same card rank, the processor comparing the card rank of the dealer hand with the player hand, wherein the final outcome is determined as a player win responsive to the first card and the second card of the player hand having the same card rank and outranking the dealer hand; and distribute a credit to the player account responsive to the determination of the final outcome as a player win.

It should be noted that any one of the aspects mentioned above may include any of the features of any of the other aspects mentioned above and may include any of the features of any of the embodiments described below as appropriate.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows.

FIG. 1 shows a playing felt designed for the game of the invention.

Drawing Components

The drawings include the following integers.
10 playing felt
12 logo
13 dealer side
14 player side
20 ante position
30 side bet position
40 player card boxes
51, 52 dealer card boxes

FIGS. 2-3 describe exemplary gaming systems and methods configured and constructed according to various embodiments of the invention;

FIG. 4 is a perspective view of an individual electronic gaming device configured for implementation of embodiments of wagering games in accordance with this disclosure;

FIG. 5 is a top view of a table configured for implementation of embodiments of wagering games in accordance with this disclosure;

FIG. 6 is a schematic diagram depicting the components of an exemplary system configured and constructed according to some embodiments of the invention;

FIG. 7 is a schematic block diagram of a gaming system for implementing embodiments of waging games in accordance with this disclosure;

FIG. 8 is a schematic block diagram of a gaming system for implementing embodiments of wagering games including a live dealer feed; and

FIG. 9 is a block diagram of a computer for acting as a gaming system for implementing embodiments of wagering games in accordance with this disclosure.

### DETAILED DESCRIPTION OF THE INVENTION

The following detailed description of the invention refers to the accompanying drawing. Wherever possible, the same reference numbers will be used in the drawing and the following description to refer to the same and like parts.

The present invention provides a card game using either a traditional or a custom deck of cards that is quick to learn, quick and fun to play and provides a reasonable and statistically predictable return for casinos.

The game is played with a dealer and one or more players. Before play commences the players place an ante bet. Each player and the dealer are then dealt 2 cards. The object of the game is to get a pair of cards scoring higher than the dealer, with a wild card being able to make a pair with any other card and two wild cards being the highest score possible. Without a pair the score is determined by the sum of the cards numeric values. Before the dealer reveals their cards, the players inspect their cards and can either forfeit their ante bet, or place a further bet equivalent to the original ante bet. A side bet is also available for receiving one or two wild cards.

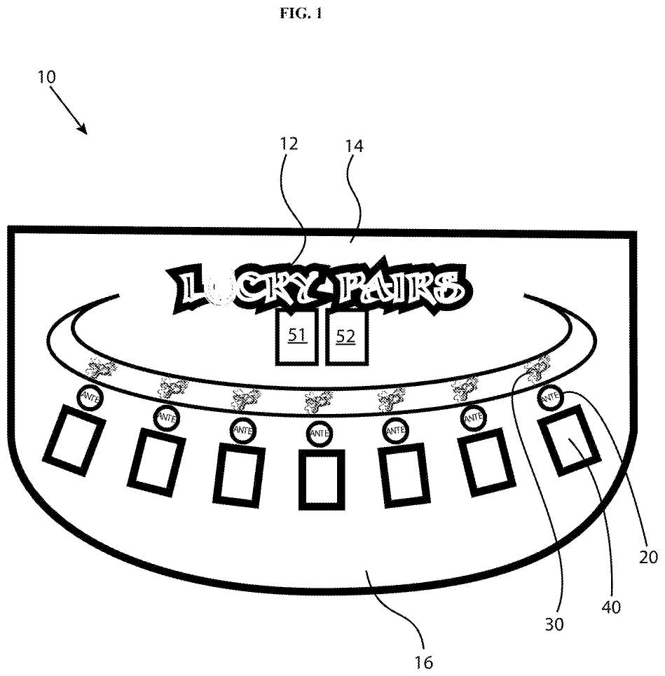

FIG. 1 shows an example playing felt for use with the game. In this instance it is configured for 7 players and will fit conveniently on a standard Blackjack table. A 10 player version fits readily on a standard Baccarat table. Playing felts for other numbers of players and varying layouts can readily be envisaged. The playing felt includes a game logo 12, ante position 20 for players to place ante bets, side bet position 30 for players to place side bets, player card box 40 to receive the cards dealt to a player and dealer card boxes 51 and 52 for receiving the cards that the dealer deals to himself The playing felt includes places for further features (not shown) in common with most gaming tables such as a pay table, chip tray, drop box and card dispenser.

Following is a detailed description of game play. The game can be played with varying types of decks including standard cards and customised playing cards. The game will be discussed in a generic sense and then specifics for two different types of cards will be discussed. The game can be played with a single deck or multiple decks of cards. Various pay tables are used depending on the type of cards, the number of decks and the desired return by the casino.

The game is played at a table with a playing felt 10 as shown in FIG. 1. The dealer stands behind the dealer side 14 of the table and the players sit on stools behind the player side 16 of the table adjacent to a player card box. To receive cards the players must first place a wager in the ante position 20. Optionally the players also place a bet in the side bet position 30. Once the ante and side bets are in place the dealer will deal a pair of cards to each player face down in the player card boxes 40 and a card face down in each of the dealer card boxes 51 and 52.

With all cards being dealt the players will then inspect their cars and decide whether or not to continue the game. At all times the players cards must remain above the table. If the players choose not to proceed, most likely if they don't have a pair and have low valued numeric cards, they place their cards face down in their player card boxes without a further bet being placed on top of the cards. In this situation the players forfeit their ante bets to the dealer. If the players choose to continue to play they must place a further bet equal to the ante bet on top of their cards face down in the players card box. Betting is closed by the dealer calling “no more bets” after which the dealer will remove the forfeited ante bets and losing cards and then turn over both of his cards. If the dealer does not have a pair or a high enough opening card total (typically 12 or 14) the dealer will not pay and announce “dealer does not open, paying all antes” and proceed to payout each player at a ratio of 1:1 of their ante. The players further bets will also be returned but with no payout. The dealer will also reveal each of the players cards to validate any wild card bets.

If the dealer has a pair or sufficient card total they will announce “dealer has opened with X” with X being a description of the dealer's cards. The dealer will then reveal each players cards in turn from left to right and assess if a player has won, drawn or lost by comparing the players cards to the dealers cards. Scores are determined by the following rules from highest to lowest: a pair of wild cards; a pair of cards with the value determined by the rank of the cards with a wild card able to be used to make a pair with any other card and will assume the rank of the other card; and, the numeric sum of each cards values. The rank and numeric value of each card is discussed further below. If the dealer scores higher than a player then the player will forfeit their ante bet and further bet. If the dealer and a player score equally then the players will retain their ante bets and further bets. If a player scores higher than the dealer then the player will retain their ante and receive a payout on their further bet as discussed further below.

The game can be played with a variety of card types, either customised or standard playing decks with rules adjusted to suit. A preferred example of a custom card deck includes four each of numeric cards from 1 to 12 plus two wild cards to give 50 cards per deck. A standard card deck with two jokers can be used with the jokers being used as wild cards. For determining the highest pairs, cards assume their normal rank with Aces high. For determining numeric totals, Aces are assigned a numeric value of 11; Kings, Queens and Jacks are assigned the same numeric value of 10; and the numbered cards assume their numeric face value. Other value assignments can be made with pay tables adjusted to suit.

With the preferred example deck the dealer opens with a pair or a total of 12 or more. For a standard deck a total of 14 or more is used.

If a dealer beats a player the player will lose their further bets and ante bets. In the case of a drawer the players will have their further bets and ante bets returned.

If the player wins they will retain their ante bet and their further bet and receive a payout on their further bet depending on their winning hand. For a game using a single deck, a pair of wild cards will be paid out at 10:1; a pair, including a pair formed with a wild card, at 2:1; and, a higher two card total at 1:1. For side bets the payout depends on the type of deck being used. For the preferred custom deck the payout is 8:1 for a single wild card and 250:1 for two wild cards. For a standard deck the payout is 9:1 for a single wild card and 250:1 for two wild cards. For games using 6 or 8 decks of cards a pair of wild cards will be paid out at 200:1 for both custom and standard decks, whilst a pair with zero or one wild card will be paid out at 7:1 for custom decks and at 8:1 for standard decks.

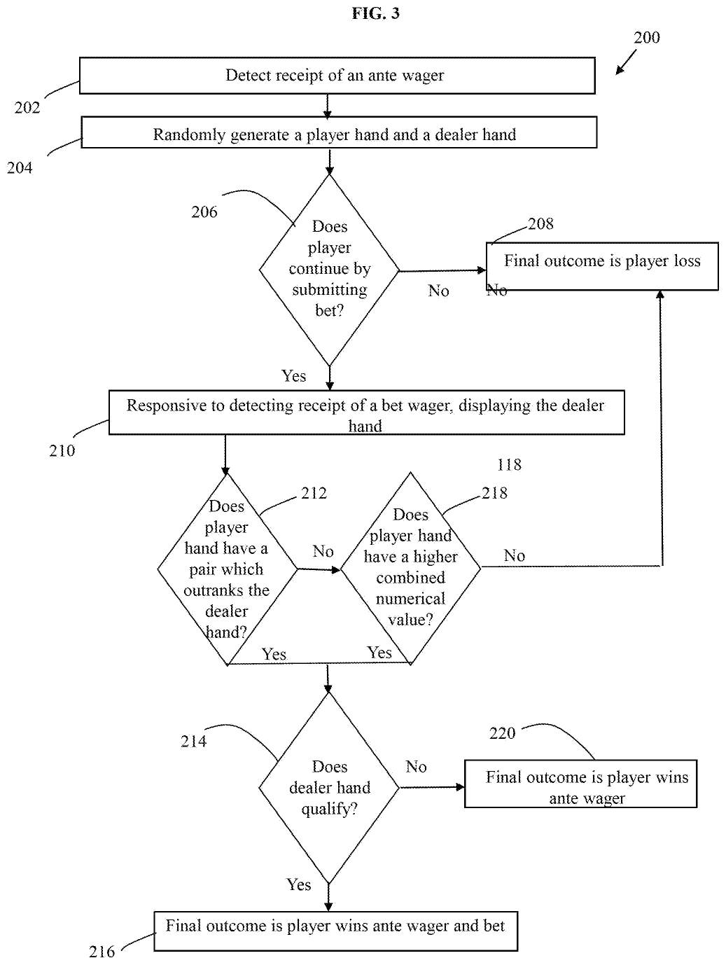

Well known analytical methods can be used to determine optimal playing strategies and returns for players and casinos. With the card configurations and payout figures discussed above and using an optimal playing strategy, the Return to Player (RTP) for custom cards will be: 99.16% for 1 deck, 99.8% for 6 decks and 99.83% for 8 decks. The corresponding House Edge (HE) measurement scaled to initial wager will be 1.41% for 1 deck, 0.34% for 6 decks and 0.28% for 8 decks. For standard decks the RTP figures are 98.21% for 1 deck, 98.96% for 6 decks and 99.00% for 8 decks; and the HE figures 3.38% for 1 deck, 2.09% for 6 decks and 2.00% for 8 decks.

The reader will now appreciate the present invention which provides a card game for gambling that is quick to learn, quick and fun to play and provides a reasonable and statistically predictable return for casinos.

Some embodiments of the invention are directed to a systems and methods of providing a card game enabling game play and wagering through a computerized platform, such as those discussed herein, which include one or more data storage devices, processors, display devices, random number generators and data communication devices, the processor being configured to execute code stored in one or more of the data storage devices to detect receipt of one or more wagers received and a selection of high or low from each participating player, actuate the random number generator to randomly generate a player hand for each participating player and a dealer hand, the processor facilitating the execution of steps such as those shown in FIG. 1.

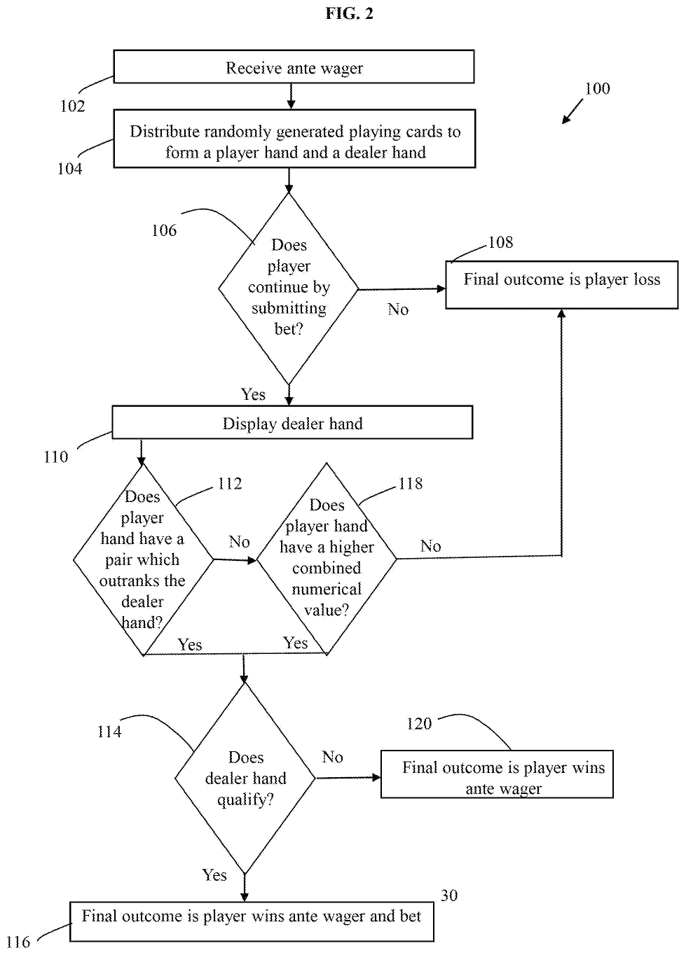

FIG. 2 illustrates an exemplary method of the invention identified by the reference number 100. In step 102, an ante wager is received. As shown by step 104, playing cards are randomly distributed to form a player hand and a dealer hand, each consisting of two cards. Any side wagers based on the player hand receiving one or two wild cards may be determined. Should the player wish to continue, as shown by step 106, a second bet or wager is received to continue the game, or if not received, then a player loses and forfeits the ante wager in step 108. As shown by step 110, the dealer hand is displayed and analyzed to determine the next steps.

As shown by step 112, if the player hand has a first and second card which are the same rank, that is, a pair, and that pair outranks the dealer hand, either because the player hand has a higher-ranking pair than a pair formed by the dealer hand (based on conventional card ranks used in poker) or because the dealer hand does not have a pair, then as shown by step 112, the final outcome is one of the player wins the ante wager and bet in step 116 or the player wins the ante wager in step 120, depending on whether the dealer hand qualifies in step 114. In this embodiment, the dealer hand qualifies in step 114 if the first card and second card in the dealer hand either form a pair or have a combined numerical value which is greater than a preset numerical value.

As shown by steps 112 and 118, if the player hand does not have a pair which outranks the dealer hand, then in step 118 the combined numerical value of the first card and second card in the player hand are compared with the combined numerical value of the first card and the second card in the dealer hand to determine if the player hand has a higher combined numerical value then the combined numerical value of the dealer hand. If the dealer hand qualifies in step 114 then the final outcome is the player wins the ante and bet wagers in step 116. If the dealer hand does not qualify in step 114 then the final outcome is the player wins the ante wager in step 120.

In some embodiments, the ante wager is paid at 1:1, that is, even money, whereas the bet wager is paid at either even money or greater odds, such as double or a multiple of the amount of the bet wager, depending on the cards in the player hand. As discussed herein, if either hand includes a wild card, then the hand is considered to be a pair hand, with the rank of the pair being determined by the other or second (non-wild) card in the hand.

As shown by steps 112 and 118, if the player hand is not a pair and the player hand does not have a higher combined numerical value than the dealer hand then final outcome is a player loss in step 108 and the player would lose the ante and bet wagers. In some embodiments, if the player hand is not a pair and the player hand does not have a higher combined numerical value than the dealer hand, then the player loses both wagers only if the dealer hand qualifies. In such embodiments, if the dealer hand does not qualify then the final outcome is either a push or the player loses only the bet wager.

FIG. 2 illustrates an exemplary embodiment of the invention generally designated by the reference number 200 involving a system and method including a computerized system in communication with a random number generator to randomly generate and display images of cards or a device for shuffling cards and distributing those random cards in step 204 which also reads the playing cards and determines game results upon receiving a wager in step 206 and displaying the dealer hand in step 210. For example, in this embodiment the player hand and/or dealer hand, are determined by such a system or device in order to determine the game play results, as shown particularly by steps 212, 214 and 218, such that for enhanced game security, integrity and automation, among other reasons, the dealer or similar personnel receives instructions or other information that facilitates the administration of a round of the game from such a system or device after the system or device determines the ranks and numerical values of cards in the player hand and the dealer hand, and compares the ranks or the combined numerical values for the purpose of determining the outcome of the ante and bet wagers received in steps 202 and 204, respectively. The system or device may thereafter determine the final outcome in steps 208, 216 and 220.

In some embodiments, the system and method employ a device for reading playing cards and determining intermediary and/or final game results, such as the player hand and/or dealer hand, such that the dealer or similar personnel may receive instructions or other information that facilitates the administration of a round of the game by, among other things, displaying on a display device instructions for forming or determining the rank of the player hand, the dealer hand, and comparing the ranks or other playing card and hand information for the purpose of determining the outcome of wagers placed.

In some embodiments, a display device is mounted in a gaming table surface and connected with a shuffler or card shoe device with a card reader. The card reader communicates the identity of each playing card and is in communication with a player position detection device or dealer input device for receiving player information so that the number of players in the round is known. A processing device and memory storing game information is then able to determine all hands in the game as well. Since all cards are read as they are dealt, including any face down cards, and the system is able to determine the hands receiving each card, the system may also be configured to determine the outcome of all wagers in the round after the deal is complete, including wagers which are normally not resolved until all cards being revealed.

Some embodiments of the invention are directed to a systems and methods of providing a wagering game through a computerized platform including one or more data storage devices, processors, display devices, random number generators and data communication devices, the processor being configured to execute code stored in one or more of the data storage devices to detect receipt of one or more wagers received, actuate the random number generator to randomly generate a player hand for each participating player and a dealer hand.

In some embodiments the wagering game is conducted using physical playing cards drawn from a randomly ordered group of standard physical playing cards, such as a single deck of playing cards. In other embodiments, the wagering game is conducted by using a random number generator mapped to simulate one or more decks of randomized standard physical playing cards.

In some embodiments the placement of a wager comprises physically placing an implement representing a monetary amount in a designated area on a gaming table surface, the loss and collection of the wager comprises physically removing the implement received from the designated area on the gaming table surface, and the distribution of a payout to the player comprises placing physical implements representing monetary amounts in the designated area of the gaming table surface.

Some embodiments of the invention are directed to systems for providing the above methods, which may include one or more data communication devices, display devices, and processing devices, which may be local or remote, as necessary to provide these methods on any computerized or partially computerized platforms, online or through a local or global communication network, including mobile devices, home computers, single or multiplayer electronic gaming machines enabling play with virtual or real currency and/or virtual or real playing cards, devices or kiosks for enabling wagering on the play of a live wagering game of the invention.

Some embodiments of the invention are also directed to a non-transitory machine readable media for providing a wagering game including one or more software programs, code and/or data segments as necessary to provide any of the methods described herein on one or more machines.

It should be understood that the words “wager,” “wagering,” “betting” or “bet,” or the like, refers to any type of points, money, credits, items of value, including physical or virtual representations thereof, which are placed at stake in that they may be forfeit depending on the occurrence of machine-generated randomly generated outcomes, such as outcomes which may be provided by revealing physical playing cards drawn from one or more decks or groups of randomly-ordered physical playing cards or a random number generator for randomly generating numbers which can be mapped to identify playing card results.

Various platforms are contemplated that are suitable for implementation of embodiments of wagering games according to this disclosure. For example, embodiments of wagering games may be implemented as live table games with an in-person dealer, electronic gaming machines, partially or fully automated table games, and fully automated, network-administered games (e.g., Internet games) that either produce game results utilizing a processor, or produce a live video feed of a dealer administering a game from a remote studio.

As previously noted, any of the present methods and games may be played as a live casino game, as a hybrid casino game (with real or virtual cards), on a multi-player electronic platform, on a personal computer for practice, on a hand-held game for practice, on a legally-authorized site on the Internet, or on a play-for-fun site on the Internet, or through any other communication network.

For example, in one embodiment, the players may be remotely located from a live dealer, and a live dealer and a game table may be displayed to players on their monitors via a video feed. The players' video feeds may be transmitted to the dealer and may also be shared among the players at the table. In a sample embodiment, a central station may include a plurality of betting-type game devices and an electronic camera for each game device. A plurality of player stations, remotely located with respect to the central station, may each include a monitor, for displaying a selected game device at the central station, and input means, for selecting a game device and for placing a bet by a player at the player's station relating to an action involving an element of chance to occur at the selected game device.

FIG. 3 is a perspective view of an individual electronic gaming device 300 (e.g., an electronic gaming machine (EGM)) configured for implementing wagering games according to this disclosure. The individual electronic gaming device 300 may include an individual player position 314 including a player input area 332 configured to enable a player to interact with the individual electronic gaming device 300 through various input devices (e.g., buttons, levers, touchscreens). The individual electronic gaming device 300 may include a gaming screen 374 configured to display indicia for interacting with the individual electronic gaming device 300, such as through processing one or more programs stored in memory 340 to implement the rules of game play at the individual electronic gaming device 300. Accordingly, game play may be accommodated without involving physical playing cards, chips or other wagering elements, and live personnel. The action may instead be simulated by a control processor 350 operably coupled to the memory 340 and interacting with and controlling the individual electronic gaming device 300.

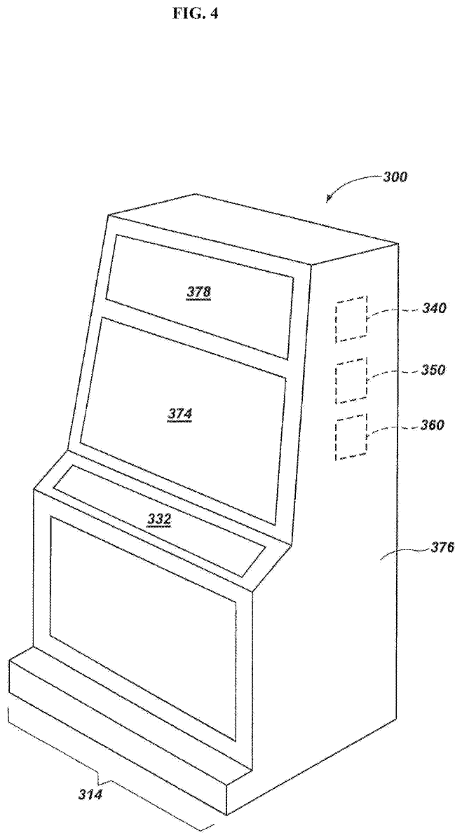

Although the individual electronic gaming device 300 displayed in FIG. 4 has an outline of a traditional gaming cabinet, the individual electronic gaming device 300 may be implemented in other ways, such as, for example, client software downloaded to a portable device, such as a smart phone, tablet, or laptop computer. The individual electronic gaming device 300 may also be a non-portable personal computer (e.g., a desktop or all-in-one computer) or other computing device. In some embodiments, client software is not downloaded but is native to the device or is otherwise delivered with the device when distributed.

A communication device 360 may be included and operably coupled to the processor 350 such that information related to operation of the individual electronic gaming device 300, information related to the game play, or combinations thereof may be communicated between the individual electronic gaming device 300 and other devices such as a server through a suitable communication medium, such, as, for example, wired networks, Wi-Fi networks, and cellular communication networks.

The gaming screen 374 may be carried by a generally vertically extending cabinet 376 of the individual electronic gaming device 300. The individual electronic gaming device 300 may further include banners to communicate rules of game play and the like, such as along a top portion 378 of the cabinet 376 of the individual electronic gaming device 300. The individual electronic gaming device 300 may further include additional decorative lights (not shown), and speakers (not shown) for transmitting and optionally receiving sounds during game play.

Some embodiments may be implemented at locations including a plurality of player stations. Such player stations may include an electronic display screen for display of game information according to the invention (e.g., cards, wagers, and game instructions) and for accepting wagers and facilitating credit balance adjustments. Such player stations may, optionally, be integrated in a table format, may be distributed throughout a casino or other gaming site, or may include both grouped and distributed player stations.

FIG. 4 is a top view of a suitable table 400 configured for implementing wagering games according to this disclosure. The table 400 may include a playing surface 404. The table 400 may include player stations 412. Each player station 412 may include a player interface 416, which may be used for displaying game information (e.g., game instructions, input options, wager information, game outcomes, etc., and accepting player elections). The player interface 416 may be a display screen in the form of a touch screen, which may be at least substantially flush with the playing surface 404 in some embodiments. Each player interface 416 may be operated by its own local game processor 414 (shown in dashed lines), although, in some embodiments, a central game processor 428 (shown in dashed lines) may be employed and may communicate directly with player interfaces 416. In some embodiments, a combination of individual local game processors 414 and the central game processor 428 may be employed.

A communication device 460 may be included and may be operably coupled to one or more of the local game processors 414, the central game processor 428, or combinations thereof, such that information related to operation of the table 400, information related to the game play, or combinations thereof may be communicated between the table 400 and other devices through a suitable communication medium, such as, for example, wired networks, Wi-Fi networks, and cellular communication networks.

Table 400 may further include additional features, such as a dealer chip tray 420, which may be used by the dealer to cash players in and out of the wagering game, whereas wagers and balance adjustments during game play may be performed using, for example, virtual chips (e.g., images or text representing wagers). For embodiments using physical cards, the table 400 may further include a card-handling device 422 (which may be configured to shuffle, read, and deliver physical cards for the dealer and players to use during game play or, alternatively, a card shoe configured to read and deliver cards that have already been randomized) and a designated area for physical cards 406, which may include locations for a dealer's hand. For embodiments using virtual cards, the virtual cards may be displayed at the individual player interfaces 416.

The table 400 may further include a dealer interface 418, which, like the player interfaces 416, may include touch screen controls for receiving dealer inputs and for assisting the dealer in administering the wagering game. The table 400 may further include an upright display 430 configured to display images that depict game information such as pay tables, hand counts, historical win/loss information by player, and a wide variety of other information considered useful to the players.

Although an embodiment is described showing individual discrete player stations, in some embodiments, the entire playing surface 404 may be an electronic display that is logically partitioned to permit game play from a plurality of players for receiving inputs from, and displaying game information to, the players, the dealer, or both.

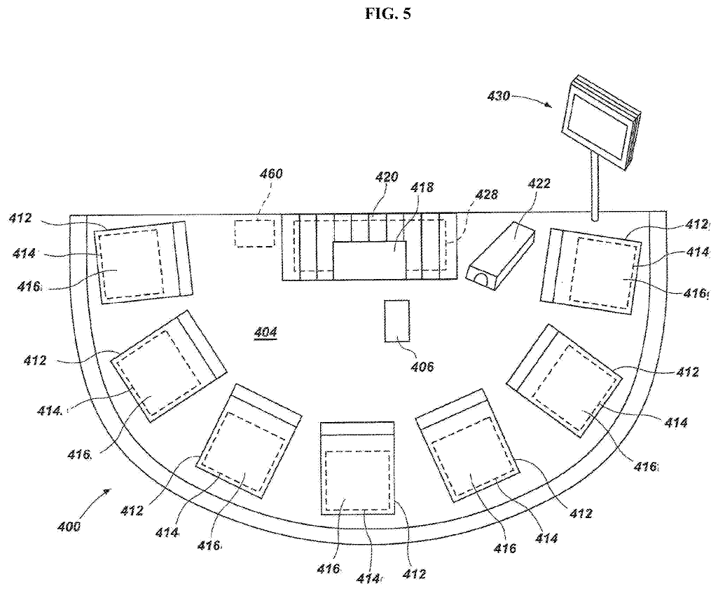

FIG. 5 illustrates a diagram of an exemplary system 500, which may be a portable device, constructed in accordance with some embodiments of the invention. System 500 includes processing device 568 in communication with a database or memory device 570, communication or data input/output device 572 and a display device 574. In some embodiments, display device 574 is a touch-enabled device and includes a data input device component. Memory device 570 may include data relating to the underlying game and embodiments of the invention as described herein, such as the side wager criteria. A player interface 576 can be presented on display device 574. Player interface 576 may be a virtual representation of a game table layout and/or one or more player positions for facilitating the transmittal and receipt of wagers in accordance with any of the embodiments herein, such as the embodiments of the invention described herein. Game outcomes are displayed and wagers are tracked using display device 574 and processing device 568 compares the respective player and banker hands, including the associated hands as described above and any bonus criteria, and determines an outcome and payout to be displayed on display device 574 accordingly.

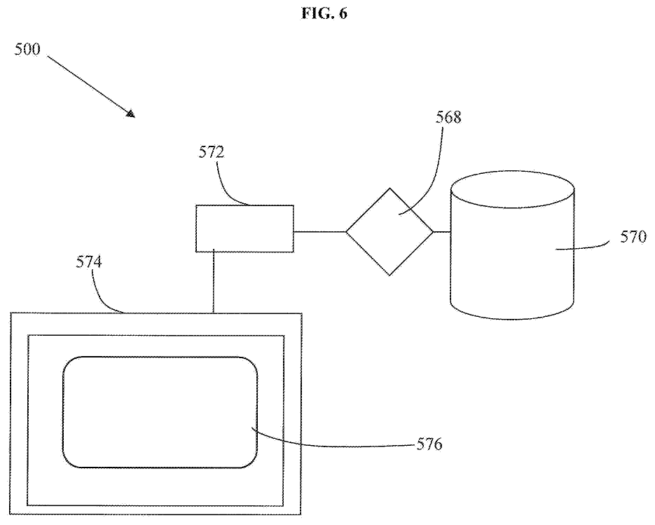

In some embodiments, wagering games in accordance with this disclosure may be administered using a gaming system employing a client-server architecture (e.g., over the Internet, a local area network, etc.). FIG. 6 is a schematic block diagram of an exemplary gaming system 600 for implementing wagering games so that end users may remotely access games as described herein, among others.

The wagering games of the invention supported by the gaming system 600 may be operated with real currency or with virtual credits or other virtual (e.g., electronic) value indicia. For example, the real currency option may be used with traditional casino and lottery-type wagering games in which money or other items of value are wagered and may be cashed out at the end of a game session. The virtual credits option may be used with wagering games in which credits (or other symbols) may be issued to a player to be used for the wagers. A player may be credited with credits in any way allowed, including, but not limited to, a player purchasing credits; being awarded credits as part of a contest or a win event in this or another game (including non-wagering games); being awarded credits as a reward for use of a product, casino, or other enterprise, time played in one session, or games played; or may be as simple as being awarded virtual credits upon logging in at a particular time or with a particular frequency, etc. Although credits may be won or lost, the ability of the player to cash out credits may be controlled or prevented. In one example, credits acquired (e.g., purchased or awarded) for use in a play-for-fun game may be limited to non-monetary redemption items, awards, or credits usable in the future or for another game or gaming session. The same credit redemption restrictions may be applied to some or all of credits won in a wagering game as well.

An additional variation includes web-based sites having both play-for-fun and wagering games, including issuance of free (non-monetary) credits usable to play the play-for-fun games. This feature may attract players to the site and to the games before they engage in wagering. In some embodiments, a limited number of free or promotional credits may be issued to entice players to play the games. Another method of issuing credits includes issuing free credits in exchange for identifying friends who may want to play. In another embodiment, additional credits may be issued after a period of time has elapsed to encourage the player to resume playing the game. The gaming system 600 may enable players to buy additional game credits to allow the player to resume play. Objects of value may be awarded to play-for-fun players, which may or may not be in a direct exchange for credits. For example, a prize may be awarded or won for a highest scoring play-for-fun player during a defined time interval. All variations of credit redemption are contemplated, as desired by game designers and game hosts (the person or entity controlling the hosting systems).

The gaming system 600 may include a gaming platform to establish a portal for an end user to access a wagering game hosted by one or more gaming servers 610 over a network 630. In embodiments, games are accessed through a user interaction service 612. The gaming system 600 enables players to interact with a user device 620 through a user input device 624 and a display 622 and to communicate with one or more gaming servers 610 using a network 630 (e.g., the Internet). Typically the user device is remote from the gaming server 610 and the network is the world wide web (i.e., internet).

In some embodiments, the gaming servers 610 may be configured as a single server to administer wagering games in combination with the user device 620. In other embodiments, the gaming servers 610 may be configured as separate servers for performing separate, dedicated functions associated with administering wagering games. Accordingly, the following description also discusses “services” with the understanding that the various services may be performed by different servers or combinations of servers in different embodiments. As shown in FIG. 6, the gaming servers 610 may include a user interaction service 612, a game service 616, and an asset service 614. In some embodiments, one or more of the gaming servers 610 may communicate with an account server 632 performing an account service 632. As explained more fully below, for some wagering type games, the account service 632 may be separate and operated by a different entity than the gaming servers 610; however, in some embodiments the account service 632 may also be operated one or more of the gaming servers 610.

The user device 620 may communicate with the user interaction service 612 through the network 630. The user interaction service 612 may communicate with the game service 616 and provide game information to the user device 620. In some embodiments, the game service 616 may also include a game engine. The game engine may comprise game rules. In some embodiments, a single user device 620 communicates with a game provided by the game service 616, while other embodiments may include a plurality of user devices 620 configured to communicate and provide end users with access to the same game provided by the game service 616. In addition, a plurality of end users may be permitted to access a single user interaction service 612, or a plurality of user interaction services 612, to access the game service 616. The user interaction service 612 may enable a user to create and access a user account and interact with game service 616. The user interaction service 612 may enable users to initiate new games, join existing games, and interface with games being played by the user.

The user interaction service 612 may also provide a client for execution on the user device 620 for accessing the gaming servers 610. The client provided by the gaming servers 610 for execution on the user device 620 may be any of a variety of implementations depending on the user device 620 and method of communication with the gaming servers 610. In one embodiment, the user device 620 may connect to the gaming servers 610 using a web browser, and the client may execute within a browser window or frame of the web browser. In another embodiment, the client may be a stand-alone executable on the user device 620.

For example, the client may comprise a relatively small amount of script, also referred to as a “script driver,” including scripting language that controls an interface of the client. The script driver may include simple function calls requesting information from the gaming servers 610. In other words, the script driver stored in the client may merely include calls to functions that are externally defined by, and executed by, the gaming servers 610. As a result, the client may be characterized as a “thin client.” The client may simply send requests to the gaming servers 610 rather than performing logic itself. The client may receive player inputs, and the player inputs may be passed to the gaming servers 610 for processing and executing the wagering game. In some embodiments, this may involve providing specific graphical display information for the display 622 as well as game outcomes.

As another example, the client may comprise an executable file rather than a script. The client may do more local processing than does a script driver, such as calculating where to show what game symbols upon receiving a game outcome from the game service 616 through user interaction service 612. In some embodiments, portions of an asset service 614 may be loaded onto the client and may be used by the client in processing and updating graphical displays. Some form of data protection, such as end-to-end encryption, may be used when data is transported over the network 630. The network 630 may be any network, such as, for example, the Internet or a local area network.

The gaming servers 610 may include an asset service 614, which may host various media assets (e.g., text, audio, video, and image files) to send to the user device 620 for presenting the various wagering games to the end user. In other words, the assets presented to the end user may be stored separately from the user device 620. For example, the user device 620 requests the assets appropriate for the game played by the user; as another example, especially relating to thin clients, just those assets that are needed for a particular display event will be sent by the gaming servers 610, including as few as one asset. The user device 620 may call a function defined at the user interaction service 612 or asset service 614, which may determine which assets are to be delivered to the user device 620 as well as how the assets are to be presented by the user device 620 to the end user. Different assets may correspond to the various user devices 620 and their clients that may have access to the game service 616 and to different variations of wagering games.

The gaming servers 610 may include the game service 616, which may be programmed to administer wagering games and determine game play outcomes to provide to the user interaction service 612 for transmission to the user device 620. For example, the game service 616 may include game rules for one or more wagering games, such that the game service 616 controls some or all of the game flow for a selected wagering game as well as the determined game outcomes. The game service 616 may include pay tables and other game logic. The game service 616 may perform random number generation for determining random game elements of the wagering game. In one embodiment, the game service 616 may be separated from the user interaction service 612 by a firewall or other method of preventing unauthorized access to the game service 612 by the general members of the network 630.

The user device 620 may present a gaming interface to the player and communicate the user interaction from the user input device 624 to the gaming servers 610. The user device 620 may be any electronic system capable of displaying gaming information, receiving user input, and communicating the user input to the gaming servers 610. For example, the user device 620 may be a desktop computer, a laptop, a tablet computer, a set-top box, a mobile device (e.g., a smartphone), a kiosk, a terminal, or another computing device. As a specific, non-limiting example, the user device 620 operating the client may be an interactive electronic gaming system 300 (see FIG. 3) or portable system 500 (see FIG. 5), as described above. The client may be a specialized application or may be executed within a generalized application capable of interpreting instructions from an interactive gaming system, such as a web browser.

The client may interface with an end user through a web page or an application that runs on a device including, but not limited to, a smartphone, a tablet, or a general computer, or the client may be any other computer program configurable to access the gaming servers 610. The client may be illustrated within a casino webpage (or other interface) indicating that the client is embedded into a webpage, which is supported by a web browser executing on the user device 620.

In some embodiments, components of the gaming system 600 may be operated by different entities. For example, the user device 620 may be operated by a third party, such as a casino or an individual, that links to the gaming servers 610, which may be operated, for example, by a wagering game service provider. Therefore, in some embodiments, the user device 620 and client may be operated by a different administrator than the operator of the game service 616. In other words, the user device 620 may be part of a third-party system that does not administer or otherwise control the gaming servers 610 or game service 616. In other embodiments, the user interaction service 612 and asset service 614 may be operated by a third-party system. For example, a gaming entity (e.g., a casino) may operate the user interaction service 612, user device 620, or combination thereof to provide its customers access to game content managed by a different entity that may control the game service 616, amongst other functionality. In still other embodiments, all functions may be operated by the same administrator. For example, a gaming entity may elect to perform each of these functions in-house, such as providing access to the user device 620, delivering the actual game content, and administering the gaming system 600.

The gaming servers 610 may communicate with one or more external account servers 632 (also referred to herein as an account service 632), optionally through another firewall. For example, the gaming servers 610 may not directly accept wagers or issue payouts. That is, the gaming servers 610 may facilitate online casino gaming but may not be part of a self-contained online casino itself. Another entity (e.g., a casino or any account holder or financial system of record) may operate and maintain its external account service 632 to accept bets and make payout distributions. The gaming servers 610 may communicate with the account service 632 to verify the existence of funds for wagering and to instruct the account service 632 to execute debits and credits. As another example, the gaming servers 610 may directly accept bets and make payout distributions, such as in the case where an administrator of the gaming servers 610 operates as a casino.

Additional features may be supported by the gaming servers 610, such as hacking and cheating detection, data storage and archival, metrics generation, messages generation, output formatting for different end user devices, as well as other features and operations.

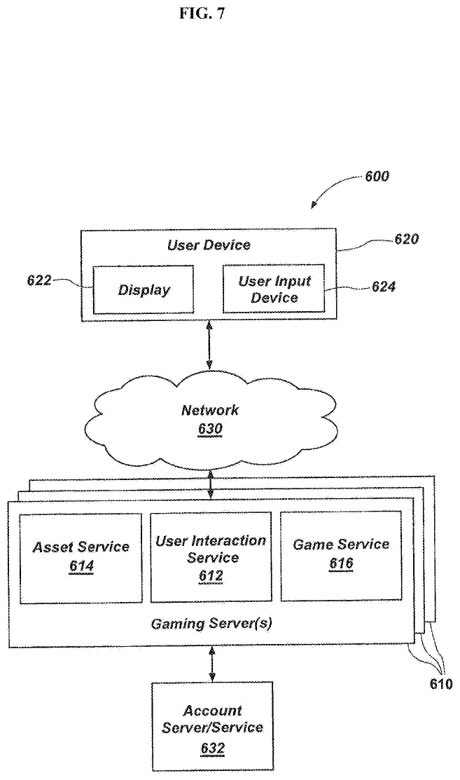

FIG. 7 is a schematic block diagram of a table 682 for implementing wagering games including a live dealer feed. Features of the gaming system 600 described above in connection with FIG. 6 may be utilized in connection with this embodiment, except as further described. Rather than cards being determined by a computerized random processes, physical cards (e.g., from a standard, 52-card deck of playing cards which include joker or other unique cards as wild cards) may be dealt by a live dealer 680 at a table 682 from a card handling system 684. A table manager 686 may assist the dealer 680 in facilitating play of the game by transmitting a video feed of the dealer's actions to the user device 620 and transmitting player elections to the dealer 680. As described above, the table manager 686 may act as or communicate with a gaming system 600 itself or as an intermediate client interposed between and operationally connected to the user device 620 and the gaming system 600 to provide gaming at the table 682 to users of the gaming system 600. Thus, the table manager 686 may communicate with the user device 620 through network 630, and may be a part of a larger online casino, or may be operated as a separate system facilitating game play. In various embodiments, each table 682 may be managed by an individual table manager 686 constituting a gaming device, which may receive and process information relating to that table. For simplicity of description, these functions are described as being performed by the table manager 686, though certain functions may be performed by an intermediary gaming system 600, such as the one shown and described in connection with FIG. 6. In some embodiments, the gaming system 600 may match remotely located players to tables 682 and facilitate transfer of information between user devices 620 and tables 682, such as wagering amounts and player option elections, without managing gameplay at individual tables. In other embodiments, functions of the table manager 686 may be incorporated into a gaming system 600.

The table 682 includes a camera 670 and optionally a microphone 672 to capture video and audio feeds relating to the table 682. The camera 670 may be trained on the dealer 680, play area 687, and card handling system 684. As the game is administered by the dealer 680, the video feed captured by the camera 670 may be shown to the player using the user device 620, and any audio captured by the microphone 672 may be played to the player using the user device 620. In some embodiments, the user device 620 may also include a camera, microphone, or both, which may also capture feeds to be shared with the dealer 680 and other players. In some embodiments, the camera 670 may be trained to capture images of the card faces, chips, and chip stacks on the surface of the gaming table and perform card recognition routines to identify the card rank and suit, which is well known in the art.

Card and wager data in some embodiments may be used by the table manger 686 to determine game outcome. The data extracted from the camera 670 may be used to confirm the card data obtained from the card handling system 684, to determine a player position that received a card, and for general security monitoring purposes.

The live video feed permits the dealer to show cards dealt by the card handling system and play the game as though the player were at a live casino. In addition, the dealer can prompt a user by announcing a player's election is to be performed. In embodiments in which a microphone 672 is included, the dealer 680 can verbally announce action or request an election by a player. In some embodiments, the user device 620 also includes a camera or microphone, which also captures feeds to be shared with the dealer 680 and other players.

The play area 687 may depict one or more player positions for playing the game. As determined by the rules of the game, the player at the user device 620 may be presented options for responding to an event in the game using a client as described with reference to FIG. 6.

Player selections may be transmitted to the table manager 686, which may display player elections to the dealer 680 using a dealer display 688 and player action indicator 690 on the table 682. For example, the dealer display 688 may display information regarding where to deal the next card or which player position is responsible for the next action.

In some embodiments, the table manager 686 may receive card information from the card handling system 684 to identify cards dealt by the card handling system 684. For example, the card handling system 684 may include a card reader to determine card information from the cards. The card information may include the rank and suit of each dealt card, and/or hand information.

The table manager 686 may apply game rules to the card information, along with the accepted player decisions, to determine gameplay events and wager results. Alternatively, the wager results may be determined by the dealer 680 and input to the table manager 686, which may be used to confirm automatically determined results by the gaming system.

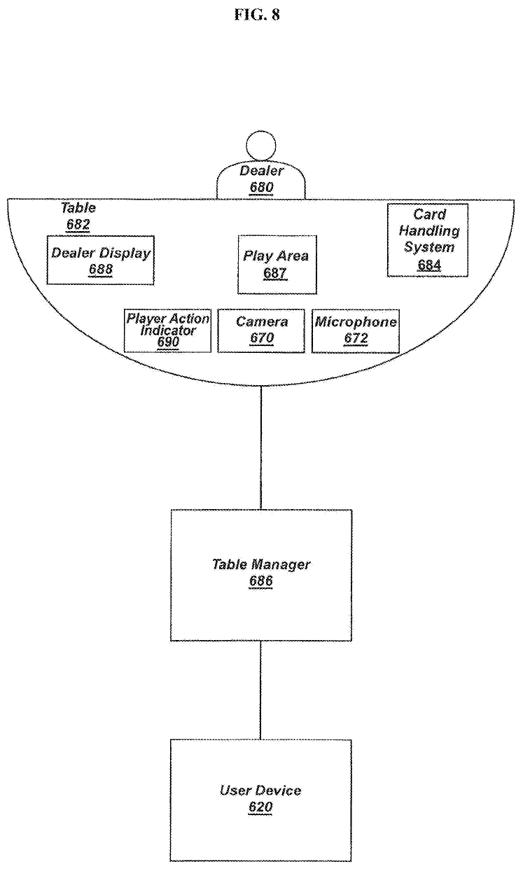

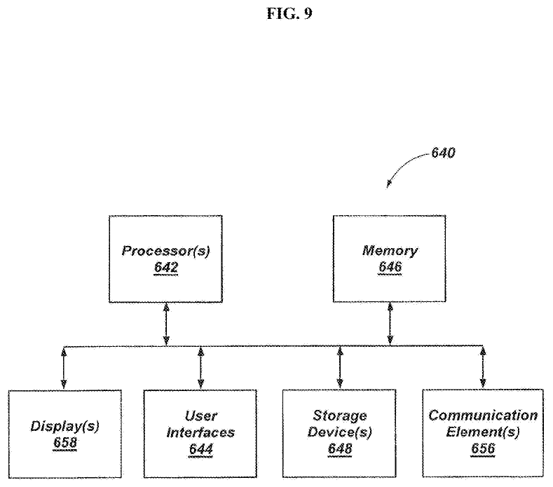

FIG. 8 is a simplified block diagram showing elements of computing devices that may be used in systems and apparatuses of this disclosure. The computing system 640 may be a user-type computer, a file server, a computer server, a notebook computer, a tablet, a handheld device, a mobile device, or other similar computer system for executing software. The computing system 640 may be configured to execute software programs containing computing instructions and may include one or more processors 642, memory 646, one or more displays 658, one or more user interface elements 644, one or more communication elements 656, and one or more storage devices 648 (also referred to herein simply as storage 648).

The processors 642 may be configured to execute a wide variety of operating systems and applications including the computing instructions for administering wagering games of the present disclosure.

The memory 646 may be used to hold computing instructions, data, and other information for performing a wide variety of tasks including administering wagering games of the present disclosure. By way of example, and not limitation, the memory646 may include Synchronous Random Access Memory (SRAM), Dynamic RAM (DRAM), Read-Only Memory (ROM), Flash memory, and the like.

The display 658 may be a wide variety of displays such as, for example, light emitting diode displays, liquid crystal displays, cathode ray tubes, and the like. In addition, the display 658 may be configured with a touch-screen feature for accepting user input as a user interface element 644.

As non-limiting examples, the user interface elements 644 may include elements such as displays, keyboards, push buttons, mice, joysticks, haptic devices, microphones, speakers, cameras, and touchscreens.

As non-limiting examples, the communication elements 656 may be configured for communicating with other devices or communication networks. As non-limiting examples, the communication elements 656 may include elements for communicating on wired and wireless communication media, such as for example, serial ports, parallel ports, Ethernet connections, universal serial bus (USB) connections, IEEE 1394 (“firewire”) connections, Thunderbolt™ connections, Bluetooth® wireless networks, ZigBee wireless networks, 802.11 type wireless networks, cellular telephone/data networks, and other suitable communication interfaces and protocols.

The storage 648 may be used for storing relatively large amounts of nonvolatile information for use in the computing system 640 and may be configured as one or more storage devices. By way of example, and not limitation, these storage devices may include computer-readable media (CRM). This CRM may include, but is not limited to, magnetic and optical storage devices such as disk drives, magnetic tape, CDs (compact discs), DVDs (digital versatile discs or digital video discs), and semiconductor devices such as RAM, DRAM, ROM, EPROM, Flash memory, and other equivalent storage devices.

A person of ordinary skill in the art will recognize that the computing system 640 may be configured in many different ways with different types of interconnecting buses between the various elements. Moreover, the various elements may be subdivided physically, functionally, or a combination thereof. As one non-limiting example, the memory 646 may be divided into cache memory, graphics memory, and main memory. Each of these memories may communicate directly or indirectly with the one or more processors 642 on separate buses, partially-combined buses, or a common bus.

Some portions of the disclosure are presented in terms of algorithms (e.g., as represented in flowcharts, prose descriptions, or both) and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulations or transformation of physical quantities or representations of physical quantities as modules or code devices, without loss of generality. However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing,” “computing,” “calculating,” “determining,” “displaying,” “determining,” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions of the embodiments can be embodied in software, firmware, or hardware, and when embodied in software, could be downloaded to reside on and be operated from different platforms used by a variety of operating systems. The embodiments can also be in a computer program product, which can be executed on a computing system.

Some embodiments also relate to an apparatus for performing the operations herein. Such an apparatus may be specially constructed for the purposes, e.g., a specific computer, or it may comprise a general-purpose computer selectively activated or reconfigured by a computer program stored in the computer. Such a computer program may be stored in a computer-readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be a transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for the purposes of enablement and best mode.

Those skilled in the art will appreciate that the types of software and hardware used are not vital to the full implementation of the methods of the invention. The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

This written description uses examples to disclose the invention and also to enable any person skilled in the art to practice the invention, including making and using any devices or systems and performing any incorporated methods. The patentable scope of the invention may include other examples that occur to those skilled in the art. Other aspects and features of the invention can be obtained from a study of the drawings and the disclosure. The invention may be practiced otherwise than as specifically described herein. It should also be noted, that the steps and/or functions listed herein, notwithstanding the order of which steps and/or functions are listed, are not limited to any specific order of operation.

Those skilled in the art will readily appreciate that the systems and methods described herein may be a standalone system, gaming device, gaming machine or incorporated in an existing gaming system or machine. The system and gaming device of the invention may include various computer and network related software and hardware, such as programs, operating systems, memory storage devices, data input/output devices, data processors, servers with links to data communication systems, wireless or otherwise, and data transceiving terminals. It should also be understood that any method steps discussed herein, such as for example, steps involving the receiving or displaying of data, may further include or involve the transmission, receipt and processing of data through conventional hardware and/or software technology to effectuate the steps as described herein. Those skilled in the art will further appreciate that the precise types of software and hardware used are not vital to the full implementation of the methods of the invention so long as players and operators thereof are provided with useful access thereto.

Further advantages and improvements may very well be made to the present invention without deviating from its scope. Although the invention has been shown and described in what is conceived to be the most practical and preferred embodiment, it is recognized that departures may be made therefrom within the scope of the invention, which is not to be limited to the details disclosed herein but is to be accorded the full scope of the claims so as to embrace any and all equivalent devices and apparatus.

Any discussion of the prior art throughout the specification should in no way be considered as an admission that such prior art is widely known or forms part of the common general knowledge in this field.

1. A system configured to enable secure wagering gaming operations through a computerized platform, the computerized platform comprising one or more of each of a data storage device, a processor, a display device, a memory storing a plurality of card images representing standard playing cards, each card image being associated with a card rank and numerical value, a random number generator and a data communication device, the processor being configured to execute code stored in the data storage device to enable the computerized platform to:
a) detect receipt through the data communication device of an ante wager received as credit from a player account;
b) responsive to detecting receipt of the wager, actuate the random number generator to randomly generate card images from the plurality of card images stored in memory to form a player hand of a first card and a second card and a dealer hand of a first card and a second card, the plurality of cards images stored in memory including at least one unique card image designated as a wild card, wherein responsive to the wild card being randomly generated to the player hand or the dealer hand, the wild card being assigned by the processing device as having the same card rank as the card rank of the second card;
c) receive a player selection, the player selection being one of forfeiting the ante wager or continuing to a final outcome, the player selection to continue to a final outcome corresponding with the receipt through the data communication device of an additional amount of credit, wherein the additional amount of credit is equal to the ante wager;
d) responsive to receiving the additional amount of credit, display the first card and the second card in the dealer hand on the display device;
e) responsive to the first card and the second card of the dealer hand having a different card rank, the processor combining the numerical value of the first card and the second card of the dealer hand to determine a combined numerical value for the dealer hand, wherein a final outcome is determined as a player win responsive to the combined numerical value for the dealer hand being greater than a preset numerical value and one of: (i) the first card and the second card of the player hand having the same card rank; or (ii) the first card and the second card of the player hand having a different card rank and a combined numerical value determined by the processor to be greater than the combined numerical value for the dealer hand;
f) responsive to the first card and the second card of the dealer hand having the same card rank, the processor comparing the card rank of the dealer hand with the player hand, wherein the final outcome is determined as a player win responsive to the first card and the second card of the player hand having the same card rank and outranking the dealer hand; and
g) distribute a credit to the player account responsive to the determination of the final outcome as a player win.

2. A method configured to enable secure wagering gaming operations through a computerized platform, the computerized platform including one or more of each of a data storage device, a processor, a display device, a memory storing a plurality of card images representing standard playing cards, each card image being associated with a card rank and numerical value, a random number generator and a data communication device, the processor being configured to execute code stored in the data storage device to enable the computerized platform to perform the method comprising the steps of:
a) detecting receipt through the data communication device of an ante wager received as credit from a player account;
b) responsive to detecting receipt of the wager, actuating the random number generator to randomly generate card images from the plurality of card images stored in memory to form a player hand of a first card and a second card and a dealer hand of a first card and a second card, the plurality of cards images stored in memory including at least one unique card image designated as a wild card, wherein responsive to the wild card being randomly generated to the player hand or the dealer hand, the wild card being assigned by the processing device as having the same card rank as the card rank of the second card;
c) receiving a player selection, the player selection being one of forfeiting the ante wager or continuing to a final outcome, the player selection to continue to a final outcome corresponding with the receipt through the data communication device of an additional amount of credit, wherein the additional amount of credit is equal to the ante wager;
d) responsive to receiving the additional amount of credit, displaying the first card and the second card in the dealer hand on the display device;
e) responsive to the first card and the second card of the dealer hand having a different card rank, the processor combining the numerical value of the first card and the second card of the dealer hand to determine a combined numerical value for the dealer hand, wherein a final outcome is determined as a player win responsive to the combined numerical value for the dealer hand being greater than a preset numerical value and one of: (i) the first card and the second card of the player hand having the same card rank; or (ii) the first card and the second card of the player hand having a different card rank and a combined numerical value determined by the processor to be greater than the combined numerical value for the dealer hand;
f) responsive to the first card and the second card of the dealer hand having the same card rank, the processor comparing the card rank of the dealer hand with the player hand, wherein the final outcome is determined as a player win responsive to the first card and the second card of the player hand having the same card rank and outranking the dealer hand; and
g) distributing a credit to the player account responsive to the determination of the final outcome as a player win.
